(19) United States
(12) Patent Application Publication
(10) Pub. No.: US 2002/0163199 A1
(43) Pub. Date: Nov. 7, 2002

(54) Method and apparatus for controlling the engine idle speed in a hybrid electric vehicle

(76) Inventors: Deepa Ramaswamy, Ypsilanti, MI (US); Joanne Theresa Woestman, Dearborn, MI (US); Mary Theresa Breida, Ann Arbor, MI (US); Stephen John Kotre, Ann Arbor, MI (US)

Correspondence Address: KEVIN G. MIERZWA, ARTZ & ARTZ, P.C., 28333 TELEGRAPH ROAD, SUITE 250, SOUTHFIELD, MI, 48034, US

(21) Appl. No.: 09/848,491

(22) Filed: May 3, 2001

(51) Int. Cl. H02P 9/00

(52) U.S. Cl. 290/40 C

(57) ABSTRACT

A method and apparatus for controlling the idle speed of a hybrid electric vehicle drive system or transaxle (10) including an internal combustion engine (12), a generator/motor (14) which is coupled to engine (12) by use of a planetary gear set (20), and an electric motor (16). Drive system (10) includes a brake or clutch assembly (34) which is operatively and selectively coupled to a generator/motor (14) and is effective to supplement the generator-produced reaction torque, thereby cooperating with the generator/motor (14) to control the idle speed of engine (12) in a wide variety of engine operating conditions.

### TECHNICAL FIELD

This invention relates to a method and an apparatus for controlling the speed of an engine, and more particularly, to a method and an apparatus which controls the idle speed of an engine within a hybrid electric vehicle.

### BACKGROUND OF THE INVENTION

Hybrid electric vehicles (“HEVs”) utilize both an internal combustion engine and one or more electric machines (e.g., motors/generators) to generate power and torque. The electric motor/generator(s) within a hybrid electric vehicle provides the vehicle with additional degrees of freedom in delivering the driver-demanded torque and may also be used to control the output speed of the engine.

In one type of hybrid electric vehicle, commonly referred to as a “power split” hybrid electric vehicle, the electric generator and the internal combustion engine are interconnected by use of a planetary gear set, and the electric generator selectively provides a reaction torque which may be used to control (e.g., to reduce and/or augment) the speed of the vehicle's engine. In this manner, the generator is used to control the speed of the engine and cooperates with the planetary gear set and a traction motor to provide a continuous variable transmission (“CVT”) effect.

The HEV presents the opportunity to have better control of engine idle speed than conventional vehicles by using the generator to control engine speed. Perceived idle quality can be improved by having tighter speed control capability via generator control of the engine speed.

### SUMMARY OF THE INVENTION

It is an object of the present invention to provide a method and system for improved control of the engine idle speed of a hybrid electric vehicle.

It is another object of the invention to provide a method and an apparatus for controlling the idle speed of an engine within a hybrid electric vehicle.

These objects are accomplished by the present invention wherein two types of engine-idle speed control are utilized and implemented. First, generator control of engine idle speed is implemented during a first set of conditions, including cold starts, low battery states of charge (SOC), replenishing the vacuum systems, purging of fuel vapor canisters, learning adaptive fuel system shifts, and during use of air conditioning.

During a second set of conditions, a second mode, engine control of engine idle speed, is implemented. These conditions include high battery SOC and generator failure.

These and other features, aspects, and advantages of the invention will become apparent by reading the following specification and by reference to the following drawings.

### BRIEF DESCRIPTION OF THE DRAWINGS

FIG. 1 is a sectional view of a “power split” hybrid electric vehicle drive system that is made in accordance with the teachings of a preferred embodiment of the present invention.

FIG. 2 is a logic flow diagram for controlling engine idle speed according to a preferred embodiment of the present invention.

### DETAILED DESCRIPTION OF THE PREFERRED EMBODIMENT OF THE INVENTION

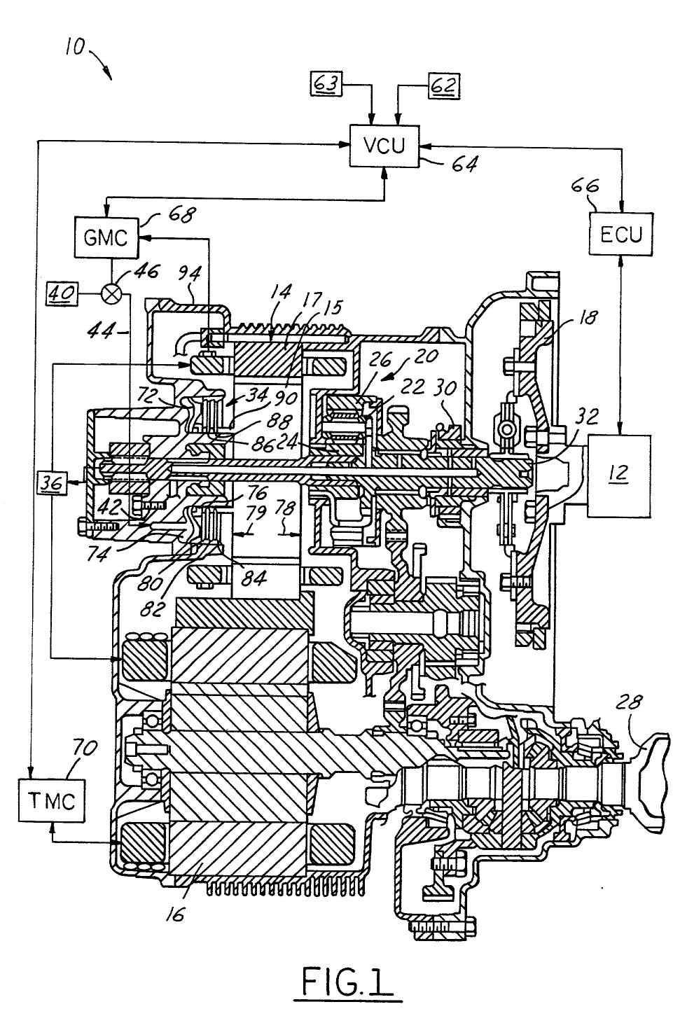

Referring now to FIG. 1, there is shown a hybrid electric vehicle transaxle or drive system 10 which is made in accordance with the teachings of the preferred embodiment of the present invention. As should be appreciated to those of ordinary skill in the art, drive system 10 is a “split-type” propulsion system, which combines the functions of both series and parallel hybrid systems, and which includes an internal combustion engine 12, an electric generator/motor 14, and an electric traction motor 16.

The engine 12 and generator 14 are interconnected by use of a conventional planetary gear set 20, including a carrier 22, a sun gear 24 and a ring gear 26. System 10 further includes a conventional flywheel and damper assembly 18, conventional one-way clutch 30 which selectively and operatively engages the output shaft 32 of engine 12, and a brake or clutch assembly 34 which selectively and operatively engages the rotor 15 of generator 14.

A conventional electrical energy storage device 36 (e.g., one or more batteries or other charge storage devices) is operatively coupled to generator 14 and to motor 16. Battery 36 receives and provides power from/to generator 14 and motor 16.

In the preferred embodiment of the invention, the engine 12 is a conventional internal combustion engine, which driveably rotates shaft 32 which is operatively coupled to the carrier 22 of the planetary gear set 20. Generator 14 is a conventional motor/generator including a stator assembly 17 and a rotor assembly 15, which is physically and operatively coupled to the sun gear 24 of the planetary gear set 20. Planetary gear set 20 allows engine 12 and generator 14 to cooperate as a “single power source” which provides a single power or torque output from the ring gear 26 of the planetary gear set 20 to the drive line 28. It should be appreciated that planetary gear set 20 further serves as a power split device that splits the output from engine 12 to the generator 14 and to the drive line 28. Generator 14 selectively provides a negative reaction torque to the engine-produced torque, thereby controlling the engine speed. By doing so, generator 14 converts rotational energy to electrical energy which is stored within battery 36 and which can be used to electrically power motor 16 and various other electrical components of the vehicle.

The electric motor 16 is a conventional electric motor which acts as a “second power source” that provides torque and power to the vehicle's drive line 28 independently from the first power source (i.e., engine 12 and generator 14). In this manner, the two power sources (i.e., the internal combustion engine and generator, as one, and electric motor, as the other) cooperatively deliver torque and power to the vehicle simultaneously and independently. The electric motor 16 further converts drive train energy into electrical energy by operating as a generator during regenerative braking and at certain other times.

In the preferred embodiment of the invention, brake or clutch assembly 34 is a conventional hydraulically operated clutch assembly. In other alternate embodiments, clutch assembly 34 may comprise any other type of selectively engageable braking or clutch assembly. A conventional source of pressurized hydraulic fluid 40 is communicatively coupled to a drum or housing portion 42 of transaxle 10 or clutch assembly 34, by use of a conventional path, tube or conduit 44. A variable solenoid valve 46, which is operatively disposed along conduit 44, and selectively controls the flow of pressurized hydraulic fluid into clutch or brake assembly 34. Particularly, variable solenoid valve 46 is communicatively coupled to and is selectively controlled by controller 68. In other alternate embodiments, valve 46 is controlled by other controllers such as the vehicle system controller 64 or the engine controller 66.

Clutch assembly 34 includes a generally ring shaped piston or member 72 which is retained within an annular groove or chamber 74 which is integrally formed within drum portion 42. Piston 72 is further operatively coupled to a conventional return spring or member 76. Piston member 72 is selectively movable within groove 74 (e.g., in the directions illustrated by arrows 78, 79). Clutch assembly 34 further includes three generally ring-shaped “friction” plates 80, 82 and 84, which are fixedly mounted to drum portion 42, and two generally ring-shaped “divider” plates 86, 88 which are fixedly coupled to rotor 15, and more particularly to hub portion 90 of rotor 15. Drum portion 42 is operatively coupled to or is integrally formed with the transaxle housing 94 and is thus rotationally stationary (i.e., portion 42 does not rotate). Hub portion 90 is operatively coupled to the rotor 15 of generator 14 and spins at a rate or speed provided by the rotor 15. Plates 80 and 84 each respectively includes an “inner” frictional surface (e.g., a frictional coating) which respectively engages plates 86 and 88, and plate 82 includes two frictional surfaces which engage plates 86 and 88. When pressurized fluid is introduced into groove 74, piston 72 is effective to move in the direction illustrated by arrow 78 and to engage plate 80, thereby compressing plates 80-88 and causing the rotation of rotor 15 to be “slowed” or stopped. Portion 42 includes a check valve 96 which allows fluid to be expelled from groove or chamber 74 when valve 46 is closed. In the preferred embodiment, cooling fluid is passed through plates 80-88 in a conventional manner, thereby preventing heat damage to the plates.

In the preferred embodiment of the invention, a central control system or vehicle control unit (“VCU”) 64 is electrically and communicatively coupled to conventional user or driver-operated controls or components 62 and to one or more conventional vehicle operating condition sensors 63. Controller 64 receives signals and/or commands generated by driver inputs 62 (e.g., gear selection, accelerator position, and braking effort commands) and vehicle operating condition sensors 63 (e.g. for vehicle speed and battery 36 state of charge) and processes and utilizes the received signals to determine the amount of torque which is to be provided to the vehicle's drive train 28. Controller 64 then generates commands to the appropriate subsystems or controllers 66, 68 and 70 which selectively provide the desired torque to the drive train 28. Particularly, controller 64 determines the total amount of torque that is to be provided or delivered to drive train 28 and partitions or divides the torque among the various subsystems.

In the preferred embodiment, each controller 64, 66, 68, 70 includes one or more microprocessors and/or integrated circuits which cooperatively control the operation of propulsion system 12. In the preferred embodiment, controller 66 comprises a conventional engine control unit or “ECU”, controller 68 comprises a conventional generator/motor controller or “GMC”, and controller 70 comprises a traction motor controller or “TMC”. Controllers 64, 66, 68, 70 may each comprise a separate controller or may be embodied within a single controller, chip, microprocessor or device.

In operation, controller 64 receives commands, data, and/or signals from driver operated controls 62 and from vehicle sensors 63. Based upon this received data, controller 64 calculates or determines the overall amount of torque which is being demanded or requested by the driver/user of the vehicle. Upon determining the desired or demanded torque, controller 64 communicates control signals to controllers 66, 68 and 70, effective to cause engine 12, generator 14 and motor 16 to cooperatively provide the demanded torque to drive train 28. Controller 64 further monitors the speed of engine 12 and selectively and controllably activates generator 14 and clutch assembly 34 to hold or maintain the speed of engine 12 at a desired level, range or value. This may be done in addition to, or in lieu of, the torque produced by the generator motor production of electricity.

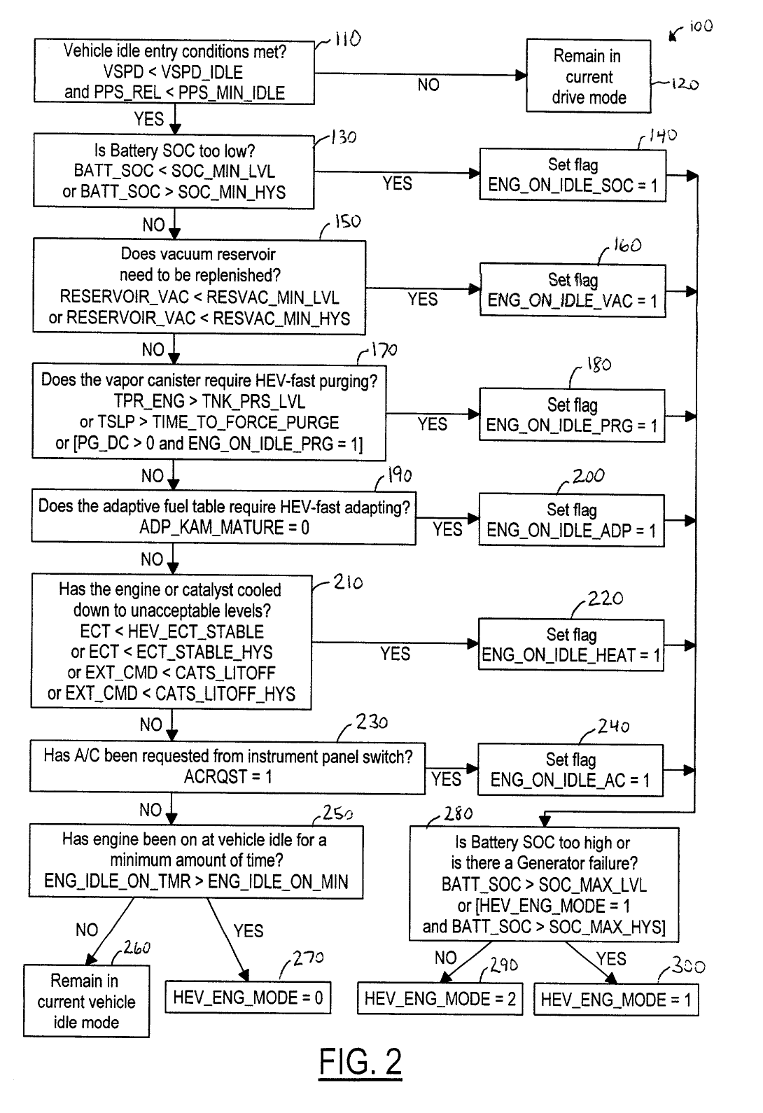

Referring now to FIG. 2, there is shown an engine idle speed control strategy 100 that is utilized by controller 64. First, in Step 110, a determination is made as to whether the vehicle idle entry conditions are met. To be in vehicle idle entry conditions, the vehicle speed (“VSPD”) must be below a predetermined minimum value (“VSPD_IDLE”) and the accelerator pedal position (“PPS_REL”) must be below a minimum level (“PPS_MIN_IDLE”). If the vehicle idle entry conditions are not met, the drive system 10 will remain in the current driving mode as in Step 120, otherwise proceed to Step 130.

In Step 130, a determination is made as to whether the battery state of charge (“BATT_SOC”) is too low. This is accomplished by either determining whether BATT_SOC is lower than a predetermined minimum value (SOC_MIN_LVL) on the first pass or whether BATT_SOC is below a predetermined level that factors in hysteresis (SOC_MIN_HYS) on any subsequent pass. If the BATT_SOC is too low, proceed to Step 140, otherwise proceed to Step 150.

In Step 140, the engine 12 is kept on at idle speed until the state of charge of the battery 36 is deemed acceptable. This is referred to as ENG_ON_IDLE_SOC=1 mode. While the engine 12 is in ENG_ON_IDLE_SOC=1 mode, the vacuum reservoir (not shown) can be replenished as per the amount of vacuum available from the amount of engine brake torque requested. Also, the conventional purge and adaptive fuel strategies may run in normal modes. Finally, the engine 12 and inferred (or measured) catalyst (not shown) temperatures will be increased or maintained naturally as the system requires. The logic then proceeds to Step 280.

In Step 150, a determination is made as to whether the vacuum needs to be replenished in the system. For example, this may include replenishing the vacuum in a climate control system's reservoir (not shown), a powertrain mount system's reservoir (not shown), and/or a brake system's reservoir (not shown). This is accomplished by determining whether the reservoir vacuum (RESERVOIR_VAC) is below a predetermined minimum level (RESVAC_MIN_LVL) on the first pass or whether RESERVOIR_VAC is below a predetermined level that factors in hysteresis (RESVAC_MIN_HYS) on any subsequent pass. If the vacuum needs replenishing, proceed to Step 160, otherwise proceed to Step 170.

In Step 160, the engine 12 is kept on at idle speed until the vacuum level reaches an acceptable level (ENG_ON_IDLE_VAC=1). This is accomplished by scheduling a desired engine brake torque that will produce enough vacuum to replenish the reservoir quickly. At the same time, the battery 36 can be charged at a rate dictated by the amount of engine brake torque requested. Further, the conventional purge and adaptive fuel strategies may be run in normal modes. Finally, engine 12 and catalyst temperatures may be increased or maintained naturally as the system requires. The logic then proceeds to Step 280.

In Step 170, a determination is made as to whether the vapor canister (not shown) requires HEV-fast purging. To determine this, one of three inquiries is made by the controller 64. The controller 64 may determine whether the fuel tank pressure (TPR_ENG) is above a predetermined maximum level (TNK_PRS_LVL). Alternatively, the controller 64 may determine whether the time since the last purge has been too long (TSLP>TIME_TO_FORCE PURGE). Also, the controller 64 may determine whether the vapor canister is already purging (PG_DC>0) and whether the engine 12 is on at idle speed until the purge is completed (ENG_ON_IDLE_PRG=1). If the answer to any of these scenarios is no, proceed to Step 190, otherwise proceed to Step 180.

In Step 180, the engine 12 is kept on at idle speed until the purging of the vapor canister is completed, where ENG_ON_IDLE_PRG=1. This is accomplished by scheduling a desired brake torque that will produce vacuum so that an aggressive purge rate can be employed to clean the vapor canister as quickly as possible. At the same time, the battery 36 can be recharged at a rate dictated by the amount of engine brake torque scheduled. Also, the vacuum reservoir can be replenished per the amount of vacuum available from the amount of brake torque scheduled. Finally, the engine 12 and catalyst temperatures will be increased or maintained naturally. Once the vapor purge is completed, proceed to Step 280.

In Step 190, a determination is made as to whether the adaptive fuel table requires HEV-fast adapting (ADP_KAM_MATURE=0). This occurs when the controller 64 has not learned the fuel system shifts (which are written to a table and “keep-alive memory”) for this particular drive cycle. If the adaptive fuel table requires HEV-Fast learning, proceed to Step 200, otherwise proceed to Step 210.

In Step 200, the engine 12 is kept on at idle speed until the fuel adapting is completed (ENG_ON_IDLE_ADP=1). This is accomplished by scheduling a desired engine brake torque that will produce the engine airflow that is needed to learn the fuel shifts. Preferably, this is accomplished by a slow sweep of brake torque to cover the range of airflows. At the same time, the battery 36 can be charged at a rate dictated by the amount of engine brake torque requested. Further, the vacuum reservoir can be replenished per the amount of vacuum available from the amount of engine brake torque requested. If air conditioning (not shown) is requested, the amount of engine torque requested will be modified slightly to accommodate the request. Finally, the engine 12 and catalyst temperatures will be increased or maintained naturally. The logic then proceeds to Step 280.

Next, in Step 210, a determination is made as to whether the engine 12 or catalyst has cooled to unacceptable levels. A two step analysis is undertaken to determine this. First, with respect to the engine 12, a determination is made on the first pass to determine if the engine 12 is too cool to provide cabin heat (ECT>HEV_ECT_STABLE) or whether ECT is below a predetermined level that factors in hysteresis (ECT_STABLE_HYS) on any subsequent pass. If the engine 12 has cooled down below the predetermined acceptable levels, proceed to step 220. If the engine 12 has not cooled below predetermined acceptable level, the catalyst is checked to see if it has cooled to unacceptable performance levels on the first pass (EXT_CMD<CATS_LITOFF) or whether EXT_CMD is below a predetermined level that factors in hysteresis (CATS_LITOFF_HYS) on any subsequent pass. If the catalysts have cooled below a predetermined acceptable level, proceed to Step 220, otherwise proceed to Step 230.

In Step 220, the engine 12 is kept on at idle speed until the ECT and catalyst temperatures reach an acceptable level (ENG_ON_IDLE_HEAT=1). This is accomplished by scheduling a desired engine brake torque that will minimize fuel consumption while producing heat the engine 12 and catalyst quickly. At the same time, the battery 36 can be charged at a rate dictated by the amount of engine brake torque requested. Further, the vacuum reservoir can be replenished per the amount of vacuum available from the amount of engine brake torque requested. Finally, the engine and catalyst temperatures will be increased or maintained naturally. The logic then proceeds to Step 280.

Next in Step 230, a determination is made as to whether air conditioning has been requested from the instrument panel switch (not shown) (ACRQST=1). If it has, proceed to Step 240, otherwise proceed to Step 250.

In Step 240, the engine 12 is kept on at idle speed until the air conditioning panel is switched off (ENG_ON_IDLE_AC=1). To accomplish this, the desired engine torque is scheduled that will minimize fuel consumption while accommodating the request for air conditioning. At the same time, the battery 36 can be charged at a rate dictated by the amount of engine brake torque requested. Further, the vacuum reservoir can be replenished per the amount of vacuum available from the amount of engine brake torque requested. Further, conventional purge and adaptive fuel strategies can be run in normal modes. Finally, the engine and catalyst temperatures will be increased or maintained naturally. The logic then proceeds to Step 280.

In Step 250, a determination is made as to whether the engine 12 has been on at vehicle idle condition for a minimum amount of time (ENG_IDLE_ON_TMR >ENG_IDLE_ON_MIN). This is done to prevent too much engine on/off cycling at vehicle idle. If the engine 12 has not been on for the minimum time, Step 260 dictates that the vehicle remain in the current idle mode. If the engine 12 has been on for the minimum time, Step 270 directs that the engine 12 is turned off (HEV_ENG_MODE=0). This can occur, for example, when a vehicle has been stopped at a stop light for a predetermined minimum amount of time. From either Step 260 or 270, the logic proceeds back to Step 110.

In Step 280, a determination is made as to whether the battery SOC is above a predetermined maximum level or whether there is generator failure. First, with respect to the battery SOC, a determination is made on the first pass to determine if the battery SOC is too high (BATT_SOC>SOC_MAX_LVL) or whether the battery SOC is above a predetermined level that factors in hysteresis (BATT_SOC>SOC_MAX_HYS) on any subsequent pass. If yes, proceed to Step 300. If no, determine whether the generator 14 has failed. If it has not, proceed to Step 290, otherwise proceed to Step 300.

In Step 290, the primary engine idle mode is activated for vehicle idle conditions (HEV_ENG_MODE=2). In this mode, the vehicle system controller 64 controls the generator 14 rotational speed, which in turn controls the engine 12 idle speed.

In Step 300, the secondary engine idle mode is activated for vehicle idle conditions (HEV_ENG_MODE=1). In this mode, the generator 14 is shut off, and the engine controller 66 controls the engine idle speed via conventional control of fuel, air flow, and ignition timing. After Steps 290 or 300, the logic proceeds back to Step 110.

The above invention provides a dual method for controlling engine idle speed in a hybrid electric vehicle to accommodate any possible HEV idle situation. The invention uses the generator coupled to a vehicle system controller to control engine speed for most of the “engine-on” idle modes. In alternative situations, such as high battery state of charge or generator failure, the vehicle system controller 64 passes control of engine idle speed to an engine controller 66. This may result in perceived tighter speed control feel by having less perturbations in engine speed.

It is understood that the invention is not limited by the exact construction or method illustrated and described above, but that various changes and/or modifications may be made without departing from the spirit and/or the scope of the inventions.

What is claimed is:

1. A method for controlling the idle speed of an engine within a hybrid electric vehicle including a generator having a rotor assembly which is operatively coupled to an engine, said method comprising the steps of:
determining whether a first set of vehicle idle entry conditions are met, wherein said first set of vehicle idle entry conditions comprises whether the vehicle is below a predetermined maximum idle speed and whether an accelerator pedal is below a predetermined minimum pedal position;
scheduling a desired engine brake torque and selectively activating a vehicle system controller to control said generator to schedule a desired engine speed and producing a first desired effect when a first set of operating conditions is present;
selectively activating an engine controller to control engine idle speed when a second set of operating conditions is present; and
turning off the engine when said first set of conditions is not present and when the engine has been in a current vehicle idle mode for a predetermined amount of time.

2. The method of claim 1, wherein the step of scheduling a desired engine brake torque and selectively activating a vehicle system controller to control said generator to schedule a desired engine speed and producing a first desired effect when a first set of operating conditions is present comprises the step of scheduling a desired engine brake torque and selectively activating a vehicle system controller to control said generator to schedule a desired engine speed to produce a first desired effect when a state of charge of a battery is below a predetermined battery minimum state of charge.

3. The method of claim 1, wherein the step of scheduling a desired engine brake torque and selectively activating a vehicle system controller to control said generator to schedule a desired engine speed and producing a first desired effect when a first set of operating conditions is present comprises the step of scheduling a desired engine brake torque and selectively activating a vehicle system controller to control said generator to schedule a desired engine speed to produce a first desired effect when a vacuum level in a climate control reservoir is below a predetermined minimum climate control vacuum level.

4. The method of claim 1, wherein the step of scheduling a desired engine brake torque and selectively activating a vehicle system controller to control said generator to schedule a desired engine speed and producing a first desired effect when a first set of operating conditions is present comprises the step of scheduling a desired engine brake torque and selectively activating a vehicle system controller to control said generator to schedule a desired engine speed to produce a first desired effect when a vacuum level in a brake system reservoir is below a predetermined brake system vacuum level.

5. The method of claim 1, wherein the step of scheduling a desired engine brake torque and selectively activating a vehicle system controller to control said generator to schedule a desired engine speed and producing a first desired effect when a first set of operating conditions is present comprises the step of scheduling a desired engine brake torque and selectively activating a vehicle system controller to control said generator to schedule a desired engine speed to produce a first desired effect when a vacuum level in a powertrain vacuum mount reservoir is below a predetermined minimum powertrain mount vacuum level.

6. The method of claim 1, wherein the step of scheduling a desired engine brake torque and selectively activating a vehicle system controller to control said generator to schedule a desired engine speed and producing a first desired effect when a first set of operating conditions is present comprises the step of scheduling a desired engine brake torque and selectively activating a vehicle system controller to control said generator to schedule a desired engine speed to produce a first desired effect when a vapor canister contained within a fuel system requires purging.

7. The method of claim 1, wherein the step of scheduling a desired engine brake torque and selectively activating a vehicle system controller to control said generator to schedule a desired engine speed and producing a first desired effect when a first set of operating conditions is present comprises the step of scheduling a desired engine brake torque and selectively activating a vehicle system controller to control said generator to schedule a desired engine speed to produce a first desired effect when an adaptive fuel table requires HEV-fast adaptive learning.

8. The method of claim 1, wherein the step of scheduling a desired engine brake torque and selectively activating a vehicle system controller to control said generator to schedule a desired engine speed and producing a first desired effect when a first set of operating conditions is present comprises the step of scheduling a desired engine brake torque and selectively activating a vehicle system controller to control said generator to schedule a desired engine speed to produce a first desired effect when the engine has cooled below a predetermined engine temperature.

9. The method of claim 1, wherein the step of scheduling a desired engine brake torque and selectively activating a vehicle system controller to control said generator to schedule a desired engine speed and producing a first desired effect when a first set of operating conditions is present comprises the step of scheduling a desired engine brake torque and selectively activating a vehicle system controller to control said generator to schedule a desired engine speed to produce a first desired effect when a catalyst has cooled below a predetermined minimum catalyst temperature.

10. The method of claim 1, wherein the step of scheduling a desired engine brake torque and selectively activating a vehicle system controller to control said generator to schedule a desired engine speed and producing a first desired effect when a first set of operating conditions is present comprises the step of scheduling a desired engine brake torque and selectively activating a vehicle system controller to control said generator to schedule a desired engine speed to produce a first desired effect when air conditioning has been requested by a vehicle operator.

11. The method of claim 1, wherein the step of selectively activating an engine controller to control engine idle speed when a second set of operating conditions is present comprises the step of selectively activating an engine controller to control engine idle speed when:
the generator has failed; or
a battery state of charge exceeds a maximum desired level.

12. A hybrid electric vehicle including a generator having a rotor assembly which is operatively coupled to an engine, the hybrid electric vehicle comprising:
a vehicle system controller for controlling the idle speed of the engine when a first set of operating conditions is present at a scheduled engine brake torque to produce a desired result; and
an engine controller for controlling the idle speed of the engine when a second set of operating conditions is present.

13. The method according to claim 11, wherein said first set of operating conditions is selected from a group consisting of a low battery state of charge, a low climate control vacuum level, a low brake system reservoir vacuum level, a low powertrain mount vacuum level, a high fuel tank vapor pressure requiring fuel vapor canister purging, a condition where the fuel vapor canister is currently being purged, a minimum time reached since previously purging the vapor canister, a low engine temperature, a low catalyst temperature, an adaptive fuel table requiring HEV-fast adaptive learning, and an activated air conditioning switch.

14. The hybrid electric vehicle of claim 12, wherein said second set of operating conditions is selected from a group consisting of a high battery state of charge and a failed generator.

15. A method for controlling the idle speed of an engine within a hybrid electric vehicle including a generator having a rotor assembly which is operatively coupled to an engine, said method comprising the steps of:
determining whether a first set of vehicle idle entry conditions are met, wherein said first set of vehicle idle entry conditions comprises whether the vehicle is below a predetermined maximum idle speed and whether an accelerator pedal is below a predetermined minimum pedal position;
scheduling a desired engine brake torque and selectively activating a vehicle system controller to control said generator to schedule a desired engine speed and produce a first desired effect when a first set of operating conditions is present, wherein said first set of operating conditions is selected from the group consisting of a low battery state of charge, a low climate control vacuum level, a low brake system reservoir vacuum level, a low powertrain mount vacuum level, a high fuel tank pressure, the existence of a minimum time period since a last vapor canister purging, the existence of current vapor canister purging, the existence of a learned adaptive fuel table for the current driving mode, a low engine temperature, a low catalyst temperature, and the state of activation of an air conditioning switch;
selectively activating an engine controller to control engine idle speed when a second set of operating conditions is present;
turning off the engine when said first set of conditions is not present and when the engine has been in a current vehicle idle mode for a predetermined amount of time, otherwise maintaining said current vehicle idle mode.

16. The method of claim 15, wherein the step of selectively activating an engine controller to control engine idle speed when a second set of operating conditions is present comprises the step of selectively activating an engine controller to control engine idle speed when:
the generator has failed; or
a battery state of charge exceeds a maximum desired level.
